(19) United States
(12) Patent Application Publication
(10) Pub. No.: US 2010/0150809 A1
(43) Pub. Date: Jun. 17, 2010

(54) ENHANCEMENTS FOR A CHLOROSILANE REDISTRIBUTION REACTOR

(76) Inventors: Jon M. Bill, JR., Humble, TX (US); Carl W. Merkh, Spring, TX (US); Charles L. Griffith, III, The Woodlands, TX (US)

Correspondence Address: TAYLOR & AUST, P.C., P.O. Box 560, 142. S Main Street, Avilla, IN, 46710, US

(21) Appl. No.: 12/635,958

(22) Filed: Dec. 11, 2009

Related U.S. Application Data
(60) Provisional application No. 61/121,791, filed on Dec. 11, 2008.

(51) Int. Cl. C01B 33/107

(52) U.S. Cl. 423/342

(57) ABSTRACT

The present invention includes a process and means for using two isolated by-products from the reaction of at least one of metallurgical silicon and silicon tetrachloride with at least one of anhydrous hydrogen chloride and hydrogen to produce trichlorosilane. The two isolated by-products are dichlorosilane and silicon tetrachloride. The present process reduces chlorosilane waste and improves efficiency of overall process for production of trichlorosilane for use in chemical vapor deposition of polysilicon for electronic and solar applications. The present invention further includes a chemical reactor for the reacting dichlorosilane with silicon tetrachloride to produce additional trichlorosilane.

### CROSS REFERENCE TO RELATED APPLICATIONS

This is a non-provisional application based upon U.S. provisional patent application Ser. No. 61/121,791, entitled “DESIGN ENHANCEMENTS FOR A CHLOROSILANE REDISTRIBUTION REACTOR”, filed Dec. 11, 2008, which is incorporated herein by reference.

### BACKGROUND OF THE INVENTION

1. Field of the Invention

The present invention relates to a process for preparing trichlorosilane, and, more particularly, to a process of preparing trichlorosilane from two isolated by-products of a reaction of metallurgical silicon and/or silicon tetrachloride, SiCl₄ with anhydrous hydrogen chloride and/or hydrogen gas.

2. Description of the Related Art

Prior art for the disportionation reactions of chlorosilanes typically utilize trichlorosilane, HSiCl₃ (hereinafter “TCS”) as a key starting reactant in the presence of a catalyst to produce dichlorosilane, H₂SiCl₂ (hereinafter “DCS”) and/or monochlorosilane, H₃SiCl, and/or silane, SiH₄. Many different types and preferred catalysts for performing such chlorosilane disportionation reactions are known in the prior art.

U.S. Pat. No. 3,627,501 establishes production of DCS and silicon tetrachloride, SiCl₄ (hereinafter “STC”) from reactant TCS using activated charcoal and/or alkali metal halides admixed with transition metal halides or cyanides as catalyst materials.

U.S. Pat. No. 3,928,542 demonstrates an advantage of pretreating a catalyst material with hydrogen chloride for the disportionation reaction of TCS to produce DCS, monochlorosilane, and silane. The catalyst material is in the form of anion exchange resin.

U.S. Pat. No. 3,968,199 demonstrates the production of silane gas from liquid TCS using a catalyst of a cross-linked anion exchange resin containing tertiary amino or quaternary ammonium groups attached through carbon bonds.

U.S. Pat. No. 4,038,371 teaches that TCS is redistributed to DCS using tetraalkylurea as a catalyst in the reaction.

U.S. Pat. Nos. 4,113,845; 4,340,574; 4,395,389; 4,610,858; 5,026,533; and 5,550,269 teach, in part, transmutation of TCS into DCS using a proprietary catalyst formulation.

U.S. Pat. No. 5,329,038 also demonstrates hydrogenation of a broad category of chlorosilanes by contact with aluminum and a hydrogen source in the presence of a catalyst material selected from transition metals and their compounds.

The prior art establishes that both DCS and silane have been used as a source of silicon in epitaxial silicon layers in manufacture of semi-conductor and solar cell devices.

After 1990, DCS was no longer widely used for the production of commercial polysilicon. Presently, a mainstay feedstock for the polysilicon industry is to use TCS as a feedstock because only this chlorosilane easily meets the ppb-purity requirements established by the polysilicon industry. TCS is also safer and considerably more stable than DCS when stored over time, which is why it maintains its ppb purity levels for months after being stored.

U.S. Pat. No. 5,118,485 teaches using a solid catalyst bed reactor fed with an enriched stream of lower-boiling silanes, such as, monochlorosilane, DCS, and silane, coming from a vent of a chemical vapor deposition (CVD) reactor and adding additional STC to produce TCS. The feedstock to the chlorosilane disportionation reaction in U.S. Pat. No. 5,118,485 is a diverse mixture of many different off gases that are vented from the CVD reactor, and DCS is not the primary constituent of the mixture of the many different off-gases.

What is needed in the art is a better means of producing electronics and solar grade TCS using isolated by-products produced from a reaction of metallurgical grade silicon and anhydrous hydrogen chloride gas in a CVD reactor or a fluid bed reactor while also reducing chlorosilane waste and improving efficiency of the overall production process.

### SUMMARY OF THE INVENTION

The present invention provides a process for producing electronics grade, semiconductor grade, and/or solar grade trichlorosilane (TCS) from silicon tetrachloride (STC) and dichlorosilane (DCS). Various exemplary embodiments of the present invention include a process for redistribution of hydrogen or disportionation of chlorosilanes to produce TCS from starting reactants DCS and STC. The process is comprised of the steps of feeding a mixture of DCS and STC into a packed bed reactor having a suitable chlorosilane redistribution catalyst; agitating and/or mixing the DCS and STC with the chlorosilane redistribution catalyst and causing turbulent flow inside the reaction containment vessel; producing TCS being substantially free of water and oxygen containing compounds; removing heat generated by the heat of reaction of the chemical reaction taking place; and purifying the TCS and separating the TCS from the excess STC, such that the TCS may be a sole or supplemental TCS feedstock for a chemical vapor deposition (CVD) reactor. As opposed to a turbulent flow, the TCS may also be produced with a laminar flow of the reactants in the reaction containment vessel designed for mixing to take place through diffusion. The process takes place in a reactor design that facilitates STC and DCS to flow through a multiplicity of packed bed reactor tubes. A molar ratio of STC to DCS is controlled at least 0.3 STC/DCS or more, preferably 1.0 STC/DCS or more, such that the STC present is in excess of what is needed to convert about 100% of the DCS to TCS.

Advantageously, the source of chlorosilane gases in the various exemplary embodiments of the present invention may be from a TCS fluid bed reactor or from the vent of a CVD reactor.

Further, in the various exemplary embodiments of the present invention, the DCS feed stream to the chlorosilane disportionation reaction primarily contains DCS with some TCS and only a trace amount of low boiling impurities, including silane and monochlorosilane. More particularly, the silane and monochlorosilane are less than approximately 5%, for example, less than approximately 1 to 2%, and less than approximately 0.2% of the DCS feed stream and the DCS is at least approximately 50%, for example, at least approximately 88% of the DCS feed stream.

In further exemplary embodiments, a chlorosilane feed stream includes STC and approximately 5 to 50 mol % DCS, for example, 16 mol % DCS. The chlorosilane stream further includes a trace amount up to approximately 3 mol % of non-chlorosilane impurities with normal boiling points less than approximately 20° C. The trace amount of low boiling point impurities include silane and monochlorosilane, the silane and monochlorosilane gases being less than approximately 1 mol % of the feed stream of chlorosilane gases, for example, 0.4 mol % and further, 0.04 mol % of the feed stream of chlorosilane gases.

### BRIEF DESCRIPTION OF THE DRAWINGS

The above-mentioned and other features and advantages of this invention, and the manner of attaining them, will become more apparent and the invention will be better understood by reference to the following description of various exemplary embodiments of the invention taken in conjunction with the accompanying drawings, wherein:

FIG. 1 is an illustration of an exemplary embodiment of a STC/DCS conversion reactor schematic wherein a process flow is downward in reaction tubes.

FIG. 2 is an illustration of an exemplary embodiment of a STC/DCS conversion reactor schematic wherein a process flow is upward in reaction tubes.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

The various exemplary embodiments of the present invention include a process and means for reacting two by-products, dichlorosilane (DCS) and silicon tetrachloride (STC), obtained in a chemical manufacture and purification process, in order to produce trichlorosilane (TCS). The present embodiments produce more TCS to be recycled back to a beginning of a TCS purification process. A net sum chemical reaction equation is stated as follows:

H₂SiCl₂+SiCl₄→2HSiCl₃+Heat of reaction evolved=+11.1 kcal/gm-mole DCS converted

Each above reactant constituent is fed to a tubular reactor as a liquid or a combination of a liquid and vapor, and the end product TCS produced is also in the form of a liquid or a combination of a liquid and a vapor.

As such, the various exemplary embodiments of the present invention increase production of TCS in an integrated TCS manufacturing process while simultaneously reducing the non-salvagable chlorosilane waste that occurs in the integrated TCS manufacturing process. This is done by taking two by-products, DCS and STC, formed in the reaction of at least one of metallurgical silicon and STC with at least one of anhydrous hydrogen chloride (HCl) gas and hydrogen gas to form more TCS. Thus, the conversion of DCS and STC reactants to TCS is maximized.

The various exemplary embodiments of the present invention substantially maximize efficiency of production and quantity of TCS for use in expitaxial deposition of high purity silicon for semiconductor and solar cell devices.

The various exemplary embodiments of the present invention utilize a fluidized bed tubular reactor packed with a catalyst material suitable for the chlorosilane hydrogen redistribution reaction.

The various exemplary embodiments are carried out in a continuous flow tubular reactor, constructed of suitable corrosion resistant chlorosilane compatible materials such as, for example, stainless steel alloy types 303, 304, 316; MONEL®; carbon steel, and the like. Metallic materials or alloys containing materials such as aluminum, zinc, tin, brass, copper are not compatible chlorosilane materials. Non-metallic materials that are chlorosilane compatible include, for example, glass, KYNAR® (PVDF), Kel-F™ (PCTFE), TEFLON®, along with GORE-TEX®, and VITON® elastomers. The orientation of the reaction with respect to the direction of flow can be substantially vertical or substantially horizontal, or any angle in between. The orientation may, for example, be substantially vertical wherein the direction of flow may be substantially upwards or substantially downwards. Such reaction can be carried out in a liquid phase or via a mixture of vapor and liquid phases. The tubular reactor is comprised of one or more internal tubes packed with a catalyst resin. Typically the internal tubes are stainless steel alloy type 304 and are each about two to about twenty feet long having an outside diameter of about three-quarters inch to about two inches. The preferred catalyst resin is a macroporous styrene cross-linked with divinylbenzene, having tertiary amine functional groups. A commercially available material having this composition is, for example, DOWEX® M-43 ion exchange resin; a weak base anion type resin material. Other weak base anion materials that may comprise the catalyst resin include, for example, DOWEX® 66, DOWEX MONSPHERE® 66, DOWEX MONSPHERE® 77, DOWEX® MWA-1, DOWEX MARATHON® WBA, XUS™ 43594.00, and the like.

Macroporous styrene, cross-linked with divinylbenzene, having tertiary amine functional groups may be used as a suitable catalyst material for the hydrogen redistribution reaction of exemplary embodiments of the present invention. The catalyst material is preferably positioned in tubular reactors using a retaining element such as a fine wire mesh screen having a mesh size smaller than the catalytic material, such as, for example, catalytic styrenic spherical particles or a slotted cap with the slots smaller than the catalytic material.

The reactor tubes are capped on each end to better ensure that the catalyst material remains in the reactor tubes with a suitable chlorosilane compatible screen material that needs to be in place on each end of each tube. The mesh size of the screen material must be smaller than the minimum particle size of the catalyst material to be used. A stainless steel screen of 70 mesh size is suitable, for example, for retaining the catalyst material DOWEX® M-43 ion exchange resin in the reactor tubes. A 70 mesh size screen has 0.0083 square inch openings and 47.9% open area.

The catalyst material should be substantially dry and be substantially without moisture, oxygen, or other volatiles before its use in the tubular reactor. After the catalyst is substantially dried, it is then inserted in the reactor tubes and warm dry pure nitrogen gas is transferred through the reactor tube beds for a period of time. At the end of the nitrogen flow time, the outlet nitrogen stream is required to be tested for presence of moisture, oxygen and other volatiles using a multi-channel analyzer suitable for measurement of moisture, oxygen, and volatile impurities, to ensure the catalyst material is sufficiently dry and in a substantially pure state.

After the catalyst is substantially dried, tested in place while packed in the reactor tubes, and certified that it meets the criteria for remaining moisture, oxygen, and volatiles, the catalyst must then be saturated with substantially pure STC liquid in which the catalyst resin undergoes an expansion process. Such catalyst resin expansion process occurs over a period of time, typically in excess of a few hours. When using DOWEX® M-43 for the catalyst material the expansion that occurs is about 7.4 volume % from its original dried volume amount. DOWEX® M-43 catalyst resin expansion process occurs over a period of time ranging from about 4 to about 24 hours.

The hydrogen redistribution reaction is started by feeding a liquid mixture of DCS and STC feedstock into an end of one or more tubular reactors. The DCS feed stream to the reactor may also include some TCS and a trace amount of low boiling impurities. Trichlorosilane produced in this hydrogen redistribution reaction gives off heat energy of 11.1 kcal/gm-mole of DCS converted. Typically the molar ratio of STC to DCS is greater than about 1:1, more for example, about 2:1, about 3:1, or about 4:1 or higher in the feedstock going into the STC/DCS conversion reactor tubes. Typical temperature range for this reaction is about 4° C. to about 35° C., under pressures ranging from about 1 to about 5 atmospheres. A conversion in excess of about 98% of DCS converted to TCS has been demonstrated when the STC/DCS molar ratio is between about 2.5 and about 4.5.

Some degree of agitation or turbulent flow of the reaction mixture through the catalyst resin bed is required. As opposed to a turbulent flow, however, the TCS may also be produced with a laminar flow of the reactants in the reaction containment vessel designed for mixing to take place through diffusion. The reaction occurs slowly under static conditions, when all reactants and catalyst resin are put together without mixing. One technique to ensure good mixing and that turbulent flow is achieved is to provide an optional recycle loop whereby a substantial fraction of the product reaction mixture flow is recycled back into the feed header using a chlorosilane recycle pump. This has the advantage for the operator to adjust flow velocity through the tubular reactor independent of the net feedstock flow to the reactor tubes to achieve turbulent flow. The feed reactants, DCS and STC, are typically and preferably mixed together before introduction to one or more tubular reactors having the catalyst resin.

The TCS product stream also contains the excess STC that was fed into the one or more tubular reactors. This excess STC can be separated from TCS using, for example, a distillation process downstream from the reactor.

In the various exemplary embodiments of the present invention, the DCS feed stream to the chlorosilane disportionation reaction primarily contains DCS with some TCS and only a trace amount of low boiling impurities, including silane and monochlorosilane. More particularly, the silane and monochlorosilane are less than approximately 5%, for example, less than approximately 1 to 2%, and less than approximately 0.2% of the DCS feed stream and the DCS is at least approximately 50%, for example, at least approximately 88% of the DCS feed stream.

In further exemplary embodiments, a chlorosilane feed stream includes STC and approximately 5 to 50 mol % DCS, for example, 16 mol % DCS. The chlorosilane stream further includes a trace amount up to approximately 3 mol % of non-chlorosilane impurities with normal boiling points less than approximately 20° C. The trace amount of low boiling point impurities include silane and monochlorosilane, the silane and monochlorosilane gases being less than approximately 1 mol % of the feed stream of chlorosilane gases, for example, 0.4 mol % and further, 0.04 mol % of the feed stream of chlorosilane gases.

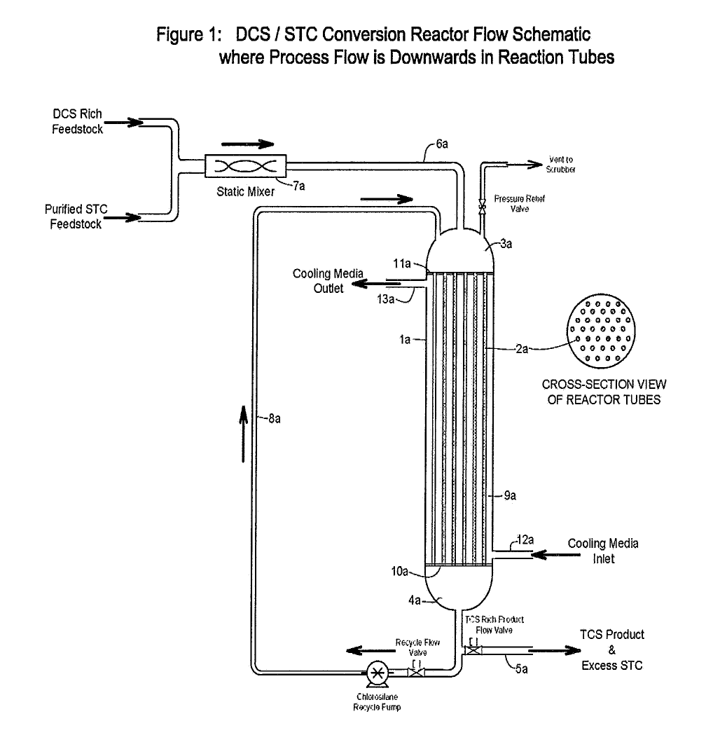

Referring now to the drawings, and more particularly to FIG. 1, there is shown a STC/DCS Conversion Reactor containment vessel that is integrated into a TCS manufacturing process for production of semiconductor or solar grade polysilicon using the improved Siemens process and/or other polysilicon manufacturing processes. One or more of the multiple reactor tubes 2a are preferably filled with a suitable solid catalyst resin material. A top header portion 3a allows for feeding reactants to the multiplicity of reactor tubes. A bottom header portion 4a is for the TCS product and excess STC effluent from the multiplicity of reaction tubes. The net sum of the TCS product and excess STC produced by the STC/DCS conversion reaction is transferred to the TCS purification process of the integrated TCS manufacturing process by way of outlet 5a. A feed reactants mixture line 6a contains DCS and purified STC that is fed to the top header portion 3a of the STC/DCS conversion reactor. A static mixer 7a premixes the DCS rich feed stream with the excess purified STC stream. An optional recycle loop 8a establishes turbulent flow through the reaction tubes and enhances substantial completion of DCS conversion. A shell side 9a of the reactor is preferably where a liquid cooling media transfers heat away from the reaction tubes. A bottom mesh screen 10a substantially prevents the solid catalyst resin from being swept out with the TCS product from the multiplicity of reaction tubes. A top mesh screen 11a substantially prevents the solid catalyst resin from floating out from the top of respective tubular reactor during time of no flow or backflows needed for flushing the catalyst beds. A cooling media inlet 12a feeds cooling media to the shell side 9a of the reactor is located towards the bottom of the tubular reactor. A cooling media outlet 13a is located towards the top of the tubular reactor.

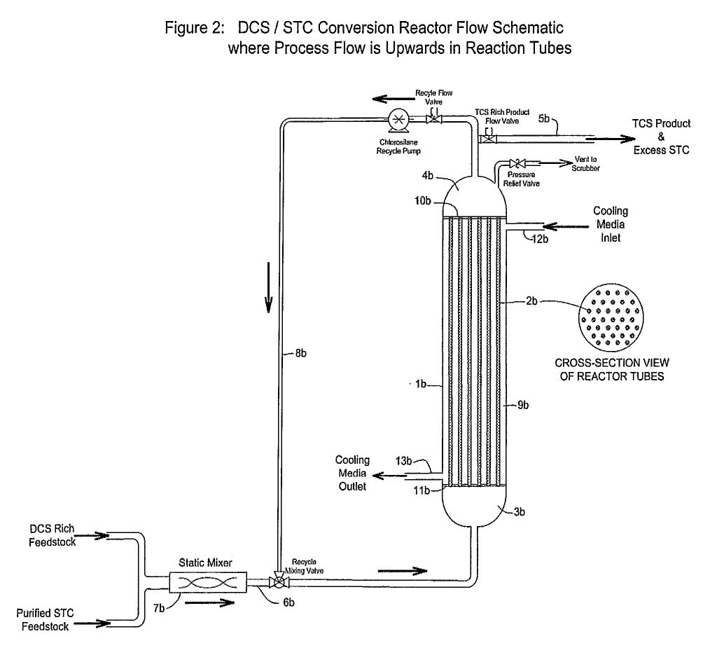

In FIG. 2, a STC/DCS Conversion Reactor containment vessel 1b is integrated into a TCS manufacturing process for production of semiconductor or solar grade polysilicon using the improved Siemens process and/or other polysilicon manufacturing processes. One or more of the multiple reactor tubes 2b are preferably filled with a suitable solid catalyst resin material. A bottom header portion 3b allows for feeding reactants to the multiplicity of reactor tubes. A top header portion 4b is for the TCS product and excess STC effluent from the multiplicity of reaction tubes. The net sum of the TCS product and excess STC produced by the STC/DCS conversion reaction is transferred to the TCS purification process of the integrated TCS manufacturing process by way of outlet 5b. A feed reactants mixture line 6b contains DCS and purified STC that is fed into the bottom header portion 3b of the STC/DCS conversion reactor. A static mixer 7b premixes the DCS rich feed stream with the excess purified STC stream. An optional recycle loop 8b can be used to establish turbulent flow through the reaction tubes and enhances substantial completion of DCS conversion. A shell side 9b of the reactor is preferably where a liquid cooling media transfers heat away from the reaction tubes. A top mesh screen 10b substantially prevents the solid catalyst resin from being swept out with the TCS product from the multiplicity of reaction tubes. A bottom retainer 11b substantially prevents the solid catalyst resin from floating out from the bottom of respective tubular reactor during time of no flow or backflows needed for flushing the catalyst beds. A cooling media inlet 12b for cooling media feed to the shell side 9b of the reactor is located towards the top of the tubular reactor. A cooling media outlet 13b is located towards the bottom of the tubular reactor.

For a commercial operation, multiple reactor tubes are typically setup in an arrangement not unlike a typical heat exchanger. A cooling media is required to surround the reactor tubes to transfer the heat away from the reactor for isothermal operation of the chemical reaction taking place inside the tubes. This cooling media may be cooling water or mixtures of ethylene glycol and water for removing the heat generated by the reaction. Other cooling media fluids could also be used. All the tubes on each end shall feed into a common header area for feeding in the reaction mixture on one end and removing the product mixtures coming out of the reactor tubes at the other end. The reactor tubes may be positioned vertically or horizontally, and if positioned vertically the feed mixture may enter in at the top or at the bottom.

The TCS produced from the hydrogen redistribution reaction containing excess STC is recycled back into the TCS purification process in which distillation methodology is utilized to readily separate STC from TCS due the significant difference in boiling points of the two materials.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A process for producing electronics grade, semiconductor grade, and/or solar grade trichlorosilane (TCS) from silicon tetrachloride (STC) and dichlorosilane (DCS), the process being comprised of the steps of:
feeding a mixture of DCS and STC into a packed bed reactor having a suitable chlorosilane redistribution catalyst;
at least one of agitating and mixing the DCS and the STC with the chlorosilane redistribution catalyst and causing turbulent flow inside the reaction containment vessel;
producing TCS being substantially free of water and oxygen containing compounds;
removing heat generated by the heat of reaction of the chemical reaction taking place; and
purifying the TCS and separating the TCS from the excess STC, such that the TCS may be one of a sole and a supplemental TCS feedstock for a chemical vapor deposition (CVD) reactor;
wherein the process takes place in a reactor design that facilitates STC and DCS to flow through a multiplicity of packed bed reactor tubes, and a molar ratio of STC to DCS is controlled at least 1.0 STC/DCS such that the STC present is in excess of what is needed to convert about 100% of the DCS to TCS.

2. The process according to claim 1, wherein a DCS feed stream provides the DCS for the mixing of the DCS with the STC, the DCS feed stream being at least approximately 50% DCS.

3. The process according to claim 2, wherein the DCS feed stream is at least approximately 88% DCS.

4. The process according to claim 3, wherein the DCS feed stream includes a the trace amount up to 12% non-chlorosilane impurities with normal boiling points less than approximately 20° C.

5. The process according to claim 4, wherein the trace amount of low boiling point impurities includes silane and monochlorosilane, the silane and monochlorosilane being less than approximately 5% of the DCS feed stream.

6. The process according to claim 5, wherein the silane and monochlorosilane are less than approximately 2% of the DCS feed stream.

7. The process according to claim 6, wherein the silane and monochlorosilane are less than approximately 0.2% of the DCS feed stream.

8. The process according to claim 1, wherein the DCS and STC are isolated by-products produced from the reaction of at least one of metallurgical grade silicon and STC and at least one of anhydrous hydrogen chloride gas and hydrogen gas in a fluidized bed reactor.

9. The process according to claim 1, wherein the DCS and STC are from off-gases produced in a CVD reactor process, where other non-chlorosilane impurities are first removed.

10. The process according to claim 1, wherein STC and DCS are fed into the reaction containment vessel as liquids or are introduced as a combination of both liquid and vapor phases.

11. The process according to claim 1, wherein the suitable chlorosilane redistribution catalyst is a weak base anion ion-exchange resin material.

12. The process according to claim 1, wherein the suitable chlorosilane redistribution catalyst is a macroporous styrene cross-linked with divinylbenzene, having tertiary amine functional groups.

13. The process according to claim 1, wherein the chlorosilane redistribution catalyst is positioned in the reactor with a screen mesh compatible with chlorosilanes, wherein openings in the screen mesh material are smaller than a diameter of the chlorosilane redistribution catalyst.

14. The process according to claim 13, wherein the screen mesh is selected from the group consisting of stainless steel, carbon steel, MONEL®, TEFLON®, and TEFLON® coated metallic or non-metallic materials.

15. The process according to claim 1, wherein the chlorosilane redistribution catalyst is pre-dried to remove substantially all residual moisture and volatile components prior to introduction into the reactor.

16. The process according to claim 15, wherein the chlorosilane redistribution catalyst is pre-dried in one of a nitrogen and an inert gas atmosphere.

17. The process according to claim 15, wherein the chlorosilane redistribution catalyst is saturated with liquid STC after being pre-dried and loaded into the chlorosilane redistribution reactor, but prior to a start of the reaction.

18. The process according to claim 1, wherein the at least one of agitating and mixing the DCS and STC with the chlorosilane redistribution catalyst includes a recycle line to feed the reaction mixture from an output of the reactor back into the input of the reactor.

19. The process according to claim 18, a flow rate of the recycle line is established independently of a net feed rate of the DCS and STC to the reactor vessel setup.

20. The process according to claim 1, wherein the removing heat is conducted with a cooling media that is temperature controlled to a temperature less than that of the mixture in the reactor, wherein the cooling media is selected from the group consisting of water, water and ethylene glycol mixture, and equivalent suitable heat transfer cooling media.

21. The process according to claim 20, wherein the cooling media is continuously flowing past at least one of vessel walls of the reactor and reactor tube walls.

22. The process according to claim 1, wherein the reactor is a fixed bed or mechanically agitated bed reactor.

23. The process according to claim 1, wherein the reactor is orientated in one of a substantially vertical, a substantially horizontal direction and any angle in between.

24. The process according to claim 23, wherein the reactor is oriented in the substantially vertical direction, with a STC/DCS feed input into one of the reactor and a bank of reactor tubes enters in at a top of the reactor and a TCS product flows out from a bottom of the reactor.

25. The process according to claim 23, wherein the reactor is oriented in the substantially vertical direction, with a STC/DCS feed input into one of the reactor and a bank of reactor tubes enters in at a bottom of the reactor and a TCS product flows out from a top of the reactor.

26. A process for producing electronics grade, semiconductor grade, and/or solar grade trichlorosilane (TCS) from silicon tetrachloride (STC) and dichlorosilane (DCS), the process being comprised of the steps of:
feeding a stream of chlorosilane gases into a packed bed reactor having a suitable chlorosilane redistribution catalyst, said stream of chlorosilane gases including STC and DCS;
at least one of agitating and mixing the stream of chlorosilane gases with the chlorosilane redistribution catalyst and causing turbulent flow inside the reaction containment vessel;
producing TCS being substantially free of water and oxygen containing compounds;
removing heat generated by the heat of reaction of the chemical reaction taking place; and
purifying the TCS and separating the TCS from the excess chlorosilane gases, such that the TCS may be one of a sole and a supplemental TCS feedstock for a chemical vapor deposition (CVD) reactor;
wherein the process takes place in a reactor design that facilitates STC and DCS to flow through a multiplicity of packed bed reactor tubes, and a molar ratio of STC to DCS is controlled at least 1.0 STC/DCS such that the STC present is in excess of what is needed to convert about 100% of the DCS to TCS.

27. The process according to claim 26, wherein the feed stream of chlorosilane gases is approximately 5 to 50 mol % DCS.

28. The process according to claim 27, wherein the feed stream of chlorosilane gases is at least approximately 16 mol % DCS.

29. The process according to claim 28, wherein the feed stream of chlorosilane gases includes a trace amount up to approximately 3 mol % non-chlorosilane impurities with normal boiling points less than approximately 20° C.

30. The process according to claim 29, wherein the trace amount of low boiling point impurities includes silane and monochlorosilane, the silane and monochlorosilane being less than approximately 1 mol % of the feed stream of chlorosilane gases.

31. The process according to claim 30, wherein the silane and monochlorosilane are less than approximately 0.4 mol % of the feed stream of chlorosilane gases.

32. The process according to claim 31, wherein the silane and monochlorosilane are less than approximately 0.04 mol % of the feed stream of chlorosilane gases.
